(19) United States
(12) Patent Application Publication
(10) Pub. No.: US 2011/0156865 A1
(43) Pub. Date: Jun. 30, 2011

(54) WIRELESS CONTROL SYSTEM AND METHOD USING MULTIPLE FINGERPRINT RECOGNITION

(75) Inventors: Seong Hak BAEK, Busan (KR); Byung Nam YUN, Busan (KR); Jae Pyung KO, Yangsan-si (KR); Jae Woo YANG, Busan (KR)

(73) Assignee: Dong-A University Research Foundation For Industry-Academy Cooperation, Busan (KR)

(21) Appl. No.: 12/969,078

(22) Filed: Dec. 15, 2010

(30) Foreign Application Priority Data
Dec. 29, 2009 (KR) 10-2009-0133452
Apr. 16, 2010 (KR) 10-2010-0035082

(51) Int. Cl. G06K 7/00; H04B 1/00

(52) U.S. Cl. 340/5.53

(57) ABSTRACT

Provided are a wireless control system and method using multiple fingerprint recognition and thus improving security and convenience by controlling a control target depending on a multiple fingerprint inputted by a user. In the wireless control method for a selected control target, a wireless control device recognizes a multiple fingerprint by receiving two or more fingerprints from a user through a fingerprint scan sensor. Then the wireless control device performs an authentication by determining whether the recognized multiple fingerprint is pre-registered. In case of a success authentication, the wireless control device creates a wireless control command for controlling a function corresponding to the recognized multiple fingerprint, and then sends the created command to a controller of the control target.

### BACKGROUND OF THE INVENTION

1. Field of the Invention

The present invention relates in general to a wireless control technology and, more particularly, to a wireless control system and method using multiple fingerprint recognition and thus improving security and convenience by controlling a control target depending on a multiple fingerprint inputted by a user.

2. Description of the Related Art

Normally for a certain control target (e.g., a car) which is exposed to the risk of being stolen, a key may be used as a tool of starting an engine or locking a door. A typical key is specially shaped and used to operate a specific lock, depending on its special shape. However, such a key may be very likely to be duplicated.

When a user desires to control the target such as an automobile, he or she has to directly insert the key into a keyway of a lock. In order to solve this inconvenience, an improved key capable of a remote control has been developed in these days.

Unfortunately, this remote control key may also be inconvenient to a user. Like a typical key, a user should always carry the remote control key. Also, a user has to manipulate a key switch of the remote control key whenever controlling the target. Besides, in case which this key is lost, there is a possibility of an unfair use of the control target by unauthorized users.

Therefore, a convention physical key or remote control key may have in common some problems in view of security and convenience.

### BRIEF SUMMARY OF THE INVENTION

Accordingly, the present invention is to address the above-mentioned problems and/or disadvantages and to offer at least the advantages described below.

One aspect of the present invention is to provide a wireless control system and method using multiple fingerprint recognition and allowing an authentication through two or more fingerprints in order to prevent a possibility of an unfair use due to a key theft.

Another aspect of the present invention is to provide a wireless control system and method using multiple fingerprint recognition and realizing a convenient use by allowing a pre-registration and a one-time execution of frequently used functions.

According to one aspect of the present invention, provided is a wireless control system using multiple fingerprint recognition. The system comprises a controller and a wireless control device. The controller is installed in a control target and is configured to control the control target in response to a wireless control command received from the wireless control device. The wireless control device is configured to recognize a multiple fingerprint by receiving two or more fingerprints from a user through a fingerprint scan sensor, to perform an authentication by determining whether the recognized multiple fingerprint is pre-registered, to create a wireless control command for controlling a function corresponding to the recognized multiple fingerprint in case of a success authentication, and to send the created command to the controller.

In the system, the control target may include at least one of a car, a motorcycle, a computer, a digital door lock, a TV, and a beam projector.

According to another aspect of the present invention, provided is a wireless control device using multiple fingerprint recognition. The device comprises a radio frequency (RF) transceiver unit, a memory unit, a fingerprint scan sensor, and a control unit. The RF transceiver unit is configured to perform a wireless communication with a control target. The memory unit is configured to store a pre-registered fingerprint. The fingerprint scan sensor is configured to receive a fingerprint from a user. The control unit is configured to recognize a multiple fingerprint by receiving two or more fingerprints from a user through a fingerprint scan sensor, to perform an authentication by determining whether the recognized multiple fingerprint is pre-registered, to create a wireless control command for controlling a function corresponding to the recognized multiple fingerprint in case of a success authentication, and to send the created command to a controller of the control target.

In the device, the control unit may be further configured to recognize the multiple fingerprint according to an entry sequence of fingerprints inputted by a user through the fingerprint scan sensor and then to perform the authentication by determining whether there is a pre-registered fingerprint corresponding to the entry sequence of fingerprints included in the recognized multiple fingerprint.

In the device, the control unit may be further configured to recognize the multiple fingerprint regardless of an entry sequence of fingerprints inputted by a user through the fingerprint scan sensor and then to perform the authentication by determining whether there is a pre-registered fingerprint corresponding to any fingerprint included in the recognized multiple fingerprint.

In the device, the fingerprint scan sensor may use one of optical and non-optical fingerprint recognition techniques.

According to still another aspect of the present invention, provided is a wireless control method for a selected control target. The method comprises a recognition step in which a wireless control device recognizes a multiple fingerprint by receiving two or more fingerprints from a user through a fingerprint scan sensor; an authentication step in which the wireless control device performs an authentication by determining whether the recognized multiple fingerprint is pre-registered; a creation step in which the wireless control device creates a wireless control command for controlling a function corresponding to the recognized multiple fingerprint in case of a success authentication; and a transmission step in which the wireless control device sends the created command to a controller of the control target.

In the method, the recognition step may include recognizing the multiple fingerprint according to an entry sequence of fingerprints inputted by a user through the fingerprint scan sensor.

In the method, the authentication step may include performing the authentication by determining whether there is a pre-registered fingerprint corresponding to the entry sequence of fingerprints included in the recognized multiple fingerprint.

In the method, the recognition step may include recognizing the multiple fingerprint regardless of an entry sequence of fingerprints inputted by a user through the fingerprint scan sensor.

In the method, the authentication step may include performing the authentication by determining whether there is a pre-registered fingerprint corresponding to any fingerprint included in the recognized multiple fingerprint.

In the method, the creation step may includes a step in which the wireless control device determines whether a current mode is an automatic function execution mode or a selected function execution mode; and in case of the automatic function execution mode, a step in which the wireless control device creates the wireless control command to control a particular function of the control target, the particular function being pre-stored as a mapping relation with the recognized multiple fingerprint.

In the method, the creation step may further include, in case of the selected function execution mode, a step in which the wireless control device creates the wireless control command by receiving a control function for controlling the control target from a user.

In the method, the control target may be a car and wherein the wireless control command may include at least one of an open or shut of a door or window, a start-up or stop of an engine, a turning on or off of a lightening system, an open or close of a trunk, and a fold or not of a side mirror.

According to aspects of the present invention, the wireless control device may perform a user authentication by using a multiple fingerprint recognized from several fingerprints inputted by a user and may also allow the authenticated user only to use the wireless control device. Therefore, the wireless control device can prevent an unfair use of the control target by unauthorized users even though the wireless control device is lost.

Additionally, since a user authentication is made through the input of several fingerprints, the wireless control device can prevent any unfavorable matter that may occur in case of a typical user authentication using a single fingerprint. For instance, even though any fingerprint still remains in the wireless control device, unauthorized users may not illegally use such a remaining fingerprint.

Also, after a user authentication, the wireless control device may allow a user to conveniently and remotely control the control target depending on a pre-registered control function for a recognized multiple fingerprint or on a selected one of control functions displayed in the function selection display unit. For instance, if the control target is a car, the wireless control device can offer the convenience of automotive control to a user by simultaneously executing two or more control functions such as a setting or release of a door lock system or a start-up of an engine.

And also, the wireless control device may draw a user's interest by allowing a user to assign desired control functions to respective multiple fingerprints. In other words, the wireless control device offers extensibility of function selection.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is a schematic view illustrating a wireless control system using multiple fingerprint recognition in accordance with an exemplary embodiment of the present invention.

FIG. 2 is a block diagram illustrating a controller of a control target shown in FIG. 1.

FIG. 3 is a schematic view illustrating an external form of a wireless control device shown in FIG. 1.

FIG. 4 is a block diagram illustrating the configuration of the wireless control device shown in FIG. 3.

FIG. 5 is a flow diagram illustrating a wireless control method using multiple fingerprint recognition in accordance with an exemplary embodiment of the present invention.

### DETAILED DESCRIPTION OF THE INVENTION

Exemplary, non-limiting embodiments of the present invention will now be described more fully with reference to the accompanying drawings. This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

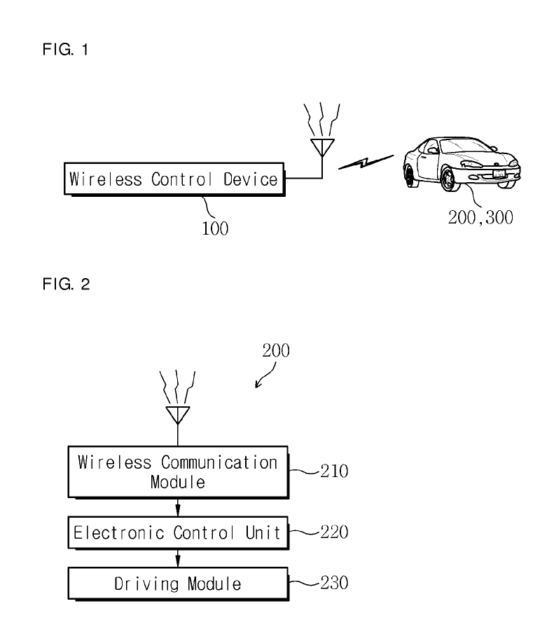

FIG. 1 is a schematic view illustrating a wireless control system using multiple fingerprint recognition in accordance with an exemplary embodiment of the present invention.

Referring to FIG. 1, the wireless control system for a certain control target 300 is composed of a wireless control device 100 and a controller 200.

The controller 200 is installed in the control target 300 and controls the whole operation of the control target 300. The controller 200 receives a wireless control command from the wireless control device 100 through a wireless communication and then enables the wireless control device 100 to operate depending on the received command.

Although a car is shown as the control target 300, this is exemplary only and not to be considered as a limitation of this invention. Alternatively, the control target 300 may include a motorcycle, a computer, a digital door lock, a TV, a beam projector, and any other electronic devices that allow or need a user's remote control. If the control target 300 is a car, the wireless control command may relate to an open or shut of a door or window, a start-up or stop of an engine, a turning on or off of a lightening system, an open or close of a trunk, a fold or not of a side mirror, and the like.

The wireless control device 100 is a kind of equipment that allows a user to carry and use. The wireless control device 100 performs a remote control for the control target 300 through a multiple fingerprint that is recognized from two or more fingerprints inputted by a user. Specifically, the wireless control device 100 recognizes a multiple fingerprint from several fingerprints inputted by a user and then performs an authentication by determining whether the recognized multiple fingerprint is pre-registered or not. After a success authentication, the wireless control device 100 creates a wireless control command for controlling a particular function of the control target 300. Here, the particular function corresponds to the recognized fingerprint. Then the wireless control device 100 sends the created command to the controller 200 of the control target 300.

At this time, the wireless control device 100 may authenticate a user through multiple fingerprint recognition and then control the control target 300 by sending a wireless control command selected by the authenticated user to the control target 300. Additionally, the wireless control device 100 may store in advance a mapping table that defines a relation between a multiple fingerprint and a pre-registered wireless control command, and then control the control target 300 by sending the pre-registered command to the control target 300 after a user authentication.

Meanwhile, the wireless control device 100 includes a mobile communication terminal (such as a cellular phone), a personal digital assistant (PDA), a portable multimedia player (PMP), a smart phone, a digital broadcast receiver based on DMB or DVB standard, and the like.

FIG. 2 is a block diagram illustrating a controller of a control target shown in FIG. 1.

Referring to FIGS. 1 and 2, the controller 200 of the control target 300 includes a wireless communication module 210, an electronic control unit (ECU) 220, and a driving module 230.

The wireless communication module 210 is a kind of unit that performs a wireless communication with the wireless control device 100. The wireless communication module 210 receives a wireless control signal from the wireless control device 100. For this, the wireless communication module 210 may have a codec for decoding data (i.e., the received wireless control signal), a modem for demodulating data, a radio frequency (RF) receiver for down-converting the frequency of received data, and a converter for converting analog data into digital data.

The ECU 220 receives the wireless control command from the wireless control device 100 through the wireless communication module 210. Then, depending on the received command, the ECU 220 sends a control signal for controlling the driving module 230 to the driving module 230.

The driving module 230 drives the control target 300 in response to the control signal of the ECU 220 so that the control target 300 can operate depending on the wireless control command. If the control target 300 is a car, the driving module 230 performs a particular function of the car, such as an open or shut of a door or window, a start-up or stop of an engine, a turning on or off of a lightening system, an open or close of a trunk, a fold or not of a side mirror, and the like.

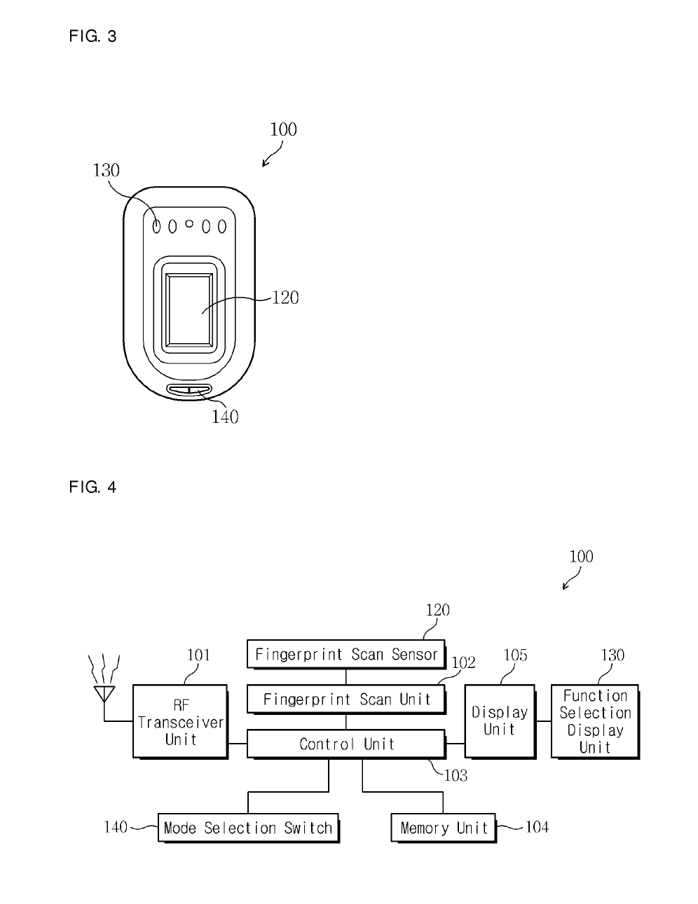

FIG. 3 is a schematic view illustrating an external form of a wireless control device shown in FIG. 1.

Referring to FIGS. 1 and 3, the wireless control device 100 includes a fingerprint scan sensor 120, a function selection display unit 130, and a mode selection switch 140.

The fingerprint scan sensor 120 allows a scanning of a user's fingerprint. When a user puts the finger on the fingerprint scan sensor 120, the wireless control device 100 scans and obtains the fingerprint. The fingerprint scan sensor 120 is a unit to input a user's fingerprint and classified into an optical type and a non-optical type. The optical type uses reflection of light, whereas the non-optical type uses pressure or heat of the finger or ultrasonic waves.

The wireless control device 100 may store a mapping table that records data describing a pre-registered function for a multiple fingerprint.

The function selection display unit 130 displays a number of control functions for the control target 300. Therefore, a user can select a desired one of the control functions through the function selection display unit 130. Also, the function selection display unit 130 performs a display only for a given time when a user is authenticated through his or her fingerprint. During a displayed time, a user can select a desired function of the control target 300. The function selection display unit 130 may be formed of LED (light emitting diode) or LCD (liquid crystal display).

The mode selection switch 140 provides a key for selecting one of a registration mode and an execution mode and a key for selecting one of an automatic function execution mode and a selected function execution mode. Herein, the registration mode refers to a particular state in which a mapping between a user's fingerprint and a control function of the control target 300 is performed. The execution mode refers to a particular state in which a user authentication is performed to control the control target 300 and also in which a control function is offered to the authenticated user only. The automatic function execution mode refers to a particular state in which a mapping relation between at least one control function of the control target 300 and a fingerprint is stored in advance and also in which a wireless control command to execute a stored function is created and transmitted when a corresponding fingerprint is inputted. The selected function execution mode refers to a particular state in which a wireless control command to execute a user's selected function of the control target 300 is created and transmitted after an authentication through a fingerprint.

FIG. 4 is a block diagram illustrating the configuration of the wireless control device shown in FIG. 3.

Referring to FIGS. 1 to 4, the wireless control device 100 includes a radio frequency (RF) transceiver unit 101, a memory unit 104, the fingerprint scan sensor 120, and a control unit 103. Additionally, the wireless control device 100 may further include a fingerprint scan unit 102, a display unit 105, the function selection display unit 130, and the mode selection switch 140. Namely, as discussed in FIG. 3, the wireless control device 100 includes the fingerprint scan sensor 120, the function selection display unit 130, and the mode selection switch 140. Also, the wireless control device 100 further includes the fingerprint scan unit 102 connected to the fingerprint scan sensor 120, the display unit 105 connected to the function selection display unit 130, and the control unit 103 connected to both the fingerprint scan unit 102 and the display unit 105. And also, the wireless control device 100 still further includes the RF transceiver unit 101 and the memory unit 104 both connected to the control unit 103. The mode selection switch 140 is also connected to the control unit 103.

The RF transceiver unit 101 performs a wireless communication with the controller 200 of the control target 300. The RF transceiver unit 101 receives a wireless control command from the control unit 103 and then sends the received command to the controller 200.

The fingerprint scan unit 102 processes a fingerprint sensing signal received from the fingerprint scan sensor 120 and then produces a fingerprint template. Then the fingerprint scan unit 102 sends the produced fingerprint template to the control unit 103. At this time, the control unit 103 stores the fingerprint template in the memory unit 104. The stored fingerprint template is used to recognize a user's fingerprint. The fingerprint scan sensor 120 may use an optical or non-optical fingerprint recognition technique.

The memory unit 104 stores a multiple fingerprint that is inputted through the fingerprint scan sensor 120 or any other equivalent. Also, the memory unit 104 stores a mapping table that defines a relation between such a multiple fingerprint and a wireless control command for controlling a function of the control target 300.

A multiple fingerprint includes information about a number of possible fingerprints that can be inputted by a user. Specifically, a multiple fingerprint may include a number of fingerprints and information about their entry sequence. Alternatively, a multiple fingerprint may include a number of fingerprints and information about their entry number and type only regardless of their entry sequence. A user can input a number of fingerprints with various combinations by using ten fingers.

The display unit 105 enables the function selection display unit 130 to display a controllable function of the control target 300. Also, when a user selects a desired function through the function selection display unit 130, the display unit 105 detects a user's section and sends it to the control unit 103.

When a user inputs a fingerprint, the control unit 103 receives a fingerprint template corresponding to the inputted fingerprint from the fingerprint scan unit 102 and then stores it in the memory unit 104. At this time, the control unit 103 can produce a multiple fingerprint by combining the fingerprint templates. Also, when a user selects an automatic control function for the control target 300 through the function selection display unit 130, the display unit 105 receives a user's section from the display unit 105, performs a mapping between a user's selected function and the inputted fingerprint template, and then stores it in the memory unit 104.

Particularly, the control unit 103 recognizes a multiple fingerprint by receiving several fingerprints from a user through the fingerprint scan sensor 120 and then performs an authentication by determining whether the recognized multiple fingerprint is pre-registered or not. After a success authentication, the control unit 103 creates a wireless control command for controlling a particular function of the control target 300. Here, the particular function corresponds to the recognized multiple fingerprint. Then the control unit 103 sends the created command to the controller 200 of the control target 300 through the RF transceiver unit 101.

The control unit 103 can perform a user authentication, as follows. Namely, the control unit 103 may recognize a multiple fingerprint according to the sequence of fingerprints inputted by a user through the fingerprint scan sensor 120 and then perform an authentication by determining whether there is a pre-registered fingerprint corresponding to the entry sequence of fingerprints included in the recognized multiple fingerprint. Alternatively, the control unit 103 may recognize a multiple fingerprint regardless of the sequence of fingerprints inputted by a user through the fingerprint scan sensor 120 and then perform an authentication by determining whether there is a pre-registered fingerprint corresponding to any fingerprint included in the recognized multiple fingerprint.

Additionally, the control unit 103 can create the wireless control command, as follows. After a success authentication, the control unit 103 determines whether a current mode is an automatic function execution mode or a selected function execution mode. In case of the automatic function execution mode, the control unit 103 may create the wireless control command to control a particular function of the control target 300 that has been already stored as a mapping relation with the recognized multiple fingerprint. In case of the selected function execution mode, the control unit 103 may create the wireless control command by receiving a control function for controlling the control target 300 from a user. If the control target 300 is a car, the wireless control command may include an open or shut of a door or window, a start-up or stop of an engine, a turning on or off of a lightening system, an open or close of a trunk, a fold or not of a side mirror, and the like.

As discussed heretofore, the wireless control device 100 according to embodiments of this invention performs a user authentication by using a multiple fingerprint recognized from several fingerprints inputted by a user and then allows the authenticated user only to use the wireless control device 100. Therefore, the wireless control device 100 can prevent an unfair use of the control target 300 by unauthorized users even though the wireless control device 100 is lost.

Additionally, since a user authentication is made through the input of several fingerprints, the wireless control device 100 according to embodiments of this invention can prevent any unfavorable matter that may occur in case of a typical user authentication using a single fingerprint. For instance, even though any fingerprint still remains in the wireless control device 100, unauthorized users may not illegally use such a remaining fingerprint.

Also, after a user authentication, the wireless control device 100 according to embodiments of this invention allows a user to conveniently and remotely control the control target 300 depending on a pre-registered control function for a recognized multiple fingerprint or on a selected one of control functions displayed in the function selection display unit 130. For instance, if the control target 300 is a car, the wireless control device 100 can offer the convenience of automotive control to a user by simultaneously executing two or more control functions such as a setting or release of a door lock system or a start-up of an engine.

And also, the wireless control device 100 according to embodiments of this invention may draw a user's interest by allowing a user to assign desired control functions to respective multiple fingerprints. In other words, the wireless control device 100 offers extensibility of function selection.

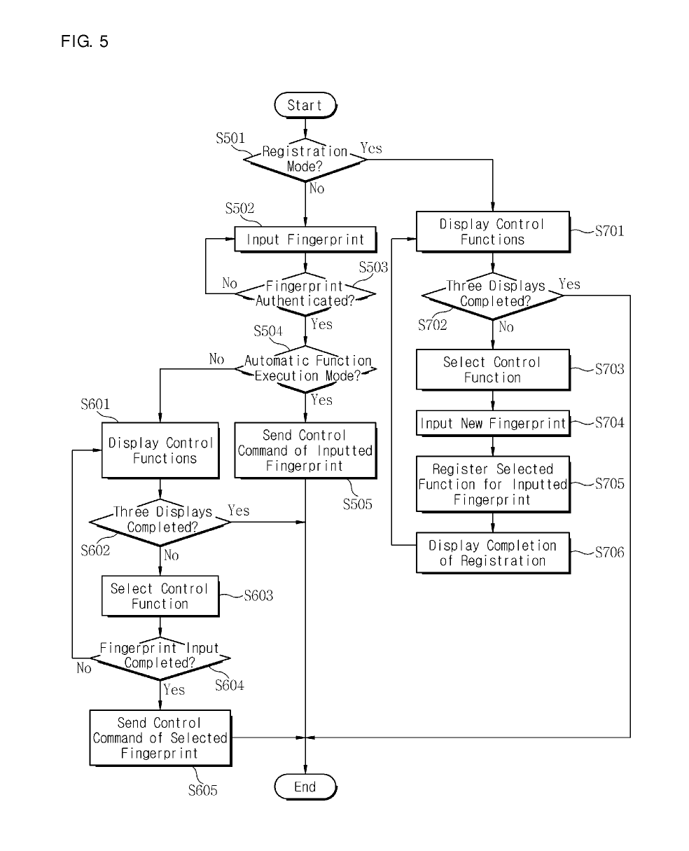

FIG. 5 is a flow diagram illustrating a wireless control method using multiple fingerprint recognition in accordance with an exemplary embodiment of the present invention.

Referring to FIGS. 1 to 5, the wireless control device 100 determines whether a current mode is a registration mode (step S501). Specifically, this determination may rely upon whether the mode selection switch 140 is set to the registration mode. A user can select one of the registration mode and the execution mode through the mode selection switch 140.

In case of the registration mode, the wireless control device 100 performs step S701. Otherwise, i.e., in case of the execution mode, the wireless control device 100 performs step S502.

If a current mode is the registration mode in the step S501, the wireless control device 100 displays control functions, namely the wireless control commands, in the function selection display unit 130 (step S701). If the control target 300 is a car, the displayed control functions may include an open or shut of a door or window, a start-up or stop of an engine, a turning on or off of a lightening system, an open or close of a trunk, a fold or not of a side mirror, and the like.

Next, the wireless control device 100 determines whether the control functions continue to be displayed for a given time (step S702). For instance, in this step S702, the wireless control device 100 may determine whether a series of three displays are completed. If the control functions are continuously displayed until the given time expires, the wireless control device 100 terminates a process.

While the control functions are displayed, the wireless control device 100 can receive a user's selection of the control functions through the function selection display unit 130. Namely, if the given time does not expire in the step S702, the wireless control device 100 receives a user's selection of the control functions through the function selection display unit 130 (step S703) and then receives the input of a new fingerprint formed of a combination of at least one fingerprint (step S704).

Then the wireless control device 100 registers a control function selected by a user and a new fingerprint inputted by a user (step S705). Namely, the wireless control device 100 performs a mapping between the selected control function and the inputted fingerprint and then records it in a mapping table. Next, the wireless control device 100 enables the display unit 105 to display the completion of registration (step S706).

Meanwhile, if a current mode is not the registration mode in the step S501, the wireless control device 100 performs a control for the control target 300 depending on a user's fingerprint input. Namely, in case of the execution mode, the wireless control device 100 receives the input of a user's fingerprint (step S502). In this step, the wireless control device 100 recognizes a multiple fingerprint by receiving several fingerprints through the fingerprint scan sensor 120.

Next, the wireless control device 100 performs a fingerprint authentication by determining whether the recognized multiple fingerprint is identical to one of pre-stored fingerprints (step S503).

Meanwhile, in the step S502, the wireless control device 100 may recognize a multiple fingerprint according to the sequence of fingerprints inputted by a user through the fingerprint scan sensor 120. Then, in the step S503, the wireless control device 100 may perform an authentication by determining whether there is a pre-registered fingerprint corresponding to the entry sequence of fingerprints included in the recognized multiple fingerprint.

Alternatively, in the step S502, the wireless control device 100 may recognize a multiple fingerprint regardless of the sequence of fingerprints inputted by a user through the fingerprint scan sensor 120. Then, in the step S503 the wireless control device 100 may perform an authentication by determining whether there is a pre-registered fingerprint corresponding to any fingerprint included in the recognized multiple fingerprint.

If the multiple fingerprint is authenticated in the step S503, the wireless control device 100 further determines whether a current mode is the automatic function execution mode (step S504). In case where a mapping relation between a control function and a multiple fingerprint is pre-registered in the steps S701 to S706, the automatic function execution mode is defined as a particular state in which, when a certain multiple fingerprint is inputted, a control function corresponding to the inputted multiple fingerprint is automatically performed. Therefore, if a current mode is the automatic function execution mode in the step S504, the wireless control device 100 creates a wireless control command to execute a pre-registered control function for the inputted multiple fingerprint and then performs transmission of the created command (step S505). Namely, the wireless control device 100 sends the created wireless control command to the controller 200.

On the other hand, if a current mode is not the automatic function execution mode in the step S504, namely in case of the selected function execution mode, the wireless control device 100 displays control functions in the function selection display unit 130 (step S601). For instance, if the control target 300 is a car, the displayed control functions may include an open or shut of a door or window, a start-up or stop of an engine, a turning on or off of a lightening system, an open or close of a trunk, a fold or not of a side mirror, and the like.

These control functions are displayed only for a given time. Therefore, the wireless control device 100 determines whether the given time for displaying the control functions expires (step S602). For instance, in this step S602, the wireless control device 100 may determine whether a series of three displays are completed.

If the given time for a control function display expires in the step S602, the wireless control device 100 terminates a process.

Otherwise, if the given time for a control function display does not expire in the step S602, the wireless control device 100 receives a user's selection of the control function for the control target 300 (step S603).

Next, the wireless control device 100 determines whether the input of a fingerprint is completed (step S604). When a user inputs again a fingerprint, the wireless control device 100 may interpret a user's re-input as the completion of a fingerprint input for performing a selected function.

If the fingerprint input is completed in the step S604, the wireless control device 100 sends a wireless control command for performing a selected function to the controller 200 (step S605).

As discussed hereinbefore, this invention may offer a good extensibility by allowing a user to assign desired control functions for the control target 300 to various multiple fingerprints each of which is produced as a combination of several fingerprints scanned through the fingerprint scan sensor 200. In addition, when applied to automotive control, this invention may effectively prevent a car theft by means of a user authentication and may also conveniently control a car without separate key manipulations.

While this invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. A wireless control system using multiple fingerprint recognition, the system comprising:
a controller installed in a control target and configured to control the control target in response to a wireless control command received from a wireless control device; and
the wireless control device configured to recognize a multiple fingerprint by receiving two or more fingerprints from a user through a fingerprint scan sensor, to perform an authentication by determining whether the recognized multiple fingerprint is pre-registered, to create a wireless control command for controlling a function corresponding to the recognized multiple fingerprint in case of a success authentication, and to send the created command to the controller.

2. The system of claim 1, wherein the control target includes at least one of a car, a motorcycle, a computer, a digital door lock, a TV, and a beam projector.

3. A wireless control device using multiple fingerprint recognition, the device comprising:
a radio frequency (RF) transceiver unit configured to perform a wireless communication with a control target;
a memory unit configured to store a pre-registered fingerprint;
a fingerprint scan sensor configured to receive a fingerprint from a user; and
a control unit configured to recognize a multiple fingerprint by receiving two or more fingerprints from a user through a fingerprint scan sensor, to perform an authentication by determining whether the recognized multiple fingerprint is pre-registered, to create a wireless control command for controlling a function corresponding to the recognized multiple fingerprint in case of a success authentication, and to send the created command to a controller of the control target.

4. The device of claim 3, wherein the control unit is further configured to recognize the multiple fingerprint according to an entry sequence of fingerprints inputted by a user through the fingerprint scan sensor and then to perform the authentication by determining whether there is a pre-registered fingerprint corresponding to the entry sequence of fingerprints included in the recognized multiple fingerprint.

5. The device of claim 3, wherein the control unit is further configured to recognize the multiple fingerprint regardless of an entry sequence of fingerprints inputted by a user through the fingerprint scan sensor and then to perform the authentication by determining whether there is a pre-registered fingerprint corresponding to any fingerprint included in the recognized multiple fingerprint.

6. The device of claim 3, wherein the fingerprint scan sensor uses one of optical and non-optical fingerprint recognition techniques.

7. A wireless control method for a selected control target, the method comprising:
a recognition step in which a wireless control device recognizes a multiple fingerprint by receiving two or more fingerprints from a user through a fingerprint scan sensor;
an authentication step in which the wireless control device performs an authentication by determining whether the recognized multiple fingerprint is pre-registered;
a creation step in which the wireless control device creates a wireless control command for controlling a function corresponding to the recognized multiple fingerprint in case of a success authentication; and
a transmission step in which the wireless control device sends the created command to a controller of the control target.

8. The method of claim 7, wherein the recognition step includes recognizing the multiple fingerprint according to an entry sequence of fingerprints inputted by a user through the fingerprint scan sensor.

9. The method of claim 8, wherein the authentication step includes performing the authentication by determining whether there is a pre-registered fingerprint corresponding to the entry sequence of fingerprints included in the recognized multiple fingerprint.

10. The method of claim 7, wherein the recognition step includes recognizing the multiple fingerprint regardless of an entry sequence of fingerprints inputted by a user through the fingerprint scan sensor.

11. The method of claim 10, wherein the authentication step includes performing the authentication by determining whether there is a pre-registered fingerprint corresponding to any fingerprint included in the recognized multiple fingerprint.

12. The method of claim 7, wherein the creation step includes:
a step in which the wireless control device determines whether a current mode is an automatic function execution mode or a selected function execution mode; and
in case of the automatic function execution mode, a step in which the wireless control device creates the wireless control command to control a particular function of the control target, the particular function being pre-stored as a mapping relation with the recognized multiple fingerprint.

13. The method of claim 12, wherein the creation step further includes:
in case of the selected function execution mode, a step in which the wireless control device creates the wireless control command by receiving a control function for controlling the control target from a user.

14. The method of claim 7, wherein the control target is a car and wherein the wireless control command includes at least one of an open or shut of a door or window, a start-up or stop of an engine, a turning on or off of a lightening system, an open or close of a trunk, and a fold or not of side mirrors.
